(19) United States
(12) Patent Application Publication
(10) Pub. No.: US 2019/0187730 A1
(43) Pub. Date: Jun. 20, 2019

(54) Mass Flow Controller

(71) Applicant: Beijing Chuangyu Technology Co., Ltd, Beijing (CN)

(72) Inventors: Qingsong ZHAO, Beijing (CN); Jianhui NAN, Beijing (CN)

(21) Appl. No.: 16/022,736

(22) Filed: Jun. 29, 2018

(30) Foreign Application Priority Data
Dec. 20, 2017 (CN) 201711386716.X

(51) Int. Cl. G05D 7/06; G05D 7/01; G01F 1/696; G01F 25/00

(52) U.S. Cl. CPC G05D 7/06; G01F 25/0053; G01F 1/6965; G05D 7/01

(57) ABSTRACT

The present disclosure relates to the technical field of semiconductors, and more particularly to a mass flow controller. The mass flow controller includes an inlet pipeline, an outlet pipeline and a control component. There are multiple inlet pipelines and/or outlet pipelines. One end of each inlet pipeline is an air inlet, and the other end of each inlet pipeline is communicated with each outlet pipeline. Each inlet pipeline is provided with a potential monitoring element. The control component is connected to each potential monitoring element, and the control component controls the gas flow of each inlet pipeline and each outlet pipeline. In order to achieve the purpose of uniform gas supply after uniform mixing of multiple gases, multiple inlet pipelines and multiple outlet pipelines may be provided, and a control component controls the gas flow of each inlet pipeline and outlet pipeline

### TECHNICAL FIELD

The present disclosure relates to the technical field of semiconductors, and more particularly to a mass flow controller.

### BACKGROUND

Today, in the rapid development of the semiconductor industry, substrate materials for chip production are becoming more and more large-sized, the internal volume of a reaction chamber for chip production is also increasing, and the flow of gas entering the reaction chamber is also increasing. How to ensure that reaction gas flow entering the reaction chamber is uniform in flow field, gas concentration and gas pressure has become an important issue to which more and more semiconductor manufacturers need to pay attention.

At present, most mass flow controllers have only one inlet and one outlet, and can control the amount or mass of a gas precisely entering the reaction chamber. When the reaction chamber has a large volume, a large gas uniformizing device is to be provided at an inlet of the reaction chamber. However, one air inlet is still difficult to ensure that gases can uniformly reach the surface of a reaction substrate at the same time or difficult to ensure that gases can uniformly remove other reaction gases remaining on the surface of the reaction substrate at the same time. There are currently two solutions for air inlet of a large chamber.

Solution A: Multiple manifolds are added directly to a pipeline at the rear end of the same mass flow controller. By increasing the inlet point of the reaction chamber, the purpose of gas uniformizing is achieved. However, the conductance of each pipeline, the length of the pipeline and the inlet position are difficult to be completely the same, which makes it difficult to ensure the uniformity of inlet, especially if the phenomenon of inlet non-uniformity, it is difficult to find reasons and make a correction.

Solution B: The same gas is first divided into multiple manifolds, a mass flow controller is disposed on each inlet manifold, and then it is connected to the reaction chamber, which can make up for the deficiencies of Solution A and can achieve the purpose of gas uniformizing by adjusting the mass flow controller on each manifold. However, this solution requires the purchase of multiple mass flow controllers, which not only increases the cost of equipment, but also designs a complex pipeline system and control system.

In addition, when a gas needs to be uniformly mixed with one or more other gases in proportion and then enters the reaction chamber, multiple mass flow controllers and a gas mixing device with a complex structure are required. In order to ensure uniform gas mixing and gas flow stability, complex back-pressure and overpressure exhaust pipelines must also be designed. In order to achieve the purpose of gas uniformizing, a lot of expensive high-purity gases is to be wasted.

### SUMMARY

### (1) Technical Problem to be Solved

The technical problem to be solved by some embodiments of the present disclosure is a problem that it is difficult for a mass flow controller in a related technology to uniformly supply gas to a large-volume reaction chamber and to achieve the purpose of uniform mixing of multiple gases and uniform gas supply.

### (2) Technical Solution

In order to solve the above technical problem, an embodiment provides a mass flow controller. The mass flow controller includes an inlet pipeline, an outlet pipeline and a control component. There are multiple inlet pipelines and/or multiple outlet pipelines. One end of each inlet pipeline is an air inlet, and the other end of each inlet pipeline is communicated with each outlet pipeline. Each inlet pipeline is provided with a potential monitoring element. The control component is connected to each potential monitoring element, and the control component controls gas flow of each inlet pipeline and each outlet pipeline.

In an exemplary embodiment, when there are multiple outlet pipelines, each outlet pipeline is provided with a first control valve, and the first control valve is connected to the control component.

In an exemplary embodiment, when there are multiple inlet pipelines, each inlet pipeline is provided with a second control valve, and the second control valve is connected to the control component.

In an exemplary embodiment, each potential monitoring element includes a gas flow bypass and a thermally sensing potential difference element, both ends of the gas flow bypass are communicated with the corresponding inlet pipeline, and the thermally sensing potential difference element is disposed on the gas flow bypass, and the thermally sensing potential difference element is connected to the control component.

In an exemplary embodiment, each thermally sensing potential difference element includes a potentiometer, a heater and two thermocouples. The heater and the thermocouples are disposed on the corresponding gas flow bypass, and the heater is located between the two thermocouples. The potentiometer is respectively connected to the two thermocouples to measure a potential difference between the two thermocouples, and the potentiometer is connected to the control component to output the potential difference to the control component.

In an exemplary embodiment, the multiple inlet pipelines include a main pipeline and an auxiliary pipeline, and the main pipeline and the auxiliary pipeline are gathered at the tail end and are connected to each outlet pipeline.

In an exemplary embodiment, a pipeline structure gathered at the tail end of the multiple inlet pipelines is a Venturi pipe.

In an exemplary embodiment, the control component includes a calculation control unit and a data exchange module, wherein the control component includes a calculation control unit and a data exchange module; the calculation control unit is connected to the data exchange module; and potential monitoring elements, first control valves and second control valves are connected to the calculation control unit.

In an exemplary embodiment, each first control valve is a piezoelectric ceramic valve.

In an exemplary embodiment, each second control valve is a piezoelectric ceramic valve.

### (3) Beneficial Effect

The above technical solution of the present disclosure has the following advantages. In the mass flow controller of the present disclosure, gas enters through the air inlet of each inlet pipeline, each potential monitoring element transmits a potential difference caused by gas flowing in the corresponding inlet pipeline to the control component, and the control component converts gas flow according to the potential difference, and respectively controls the gas inflow of each inlet pipeline and the gas outflow of each outlet pipeline according to converted data. In order to achieve the purpose of uniformly supplying gas into a large-volume reaction chamber, in an embodiment of the present disclosure, multiple outlet pipelines may be provided to supply gas into the reaction chamber, and the control component controls the gas flow of each outlet pipeline, so as to meet the requirements for uniformly supplying a large amount of gases. In order to achieve the purpose of supplying gas into the reaction chamber after uniform mixing of multiple gases, in an exemplary embodiment of the present disclosure, multiple inlet pipelines may be provided, and the control component controls gas flow of each inlet pipeline, mixes gases in the inlet pipeline according to the content requirements of each gas, and then supplies the gas into the reaction chamber, so as to meet the requirements of uniform gas mixing. In order to achieve the purpose of uniform gas supply after uniform mixing of multiple gases, in an exemplary embodiment of the present disclosure, multiple inlet pipelines and multiple outlet pipelines may be provided, and the control component controls gas flow of each inlet pipeline and outlet pipeline, so as to meet the requirements of uniform gas mixing and uniform gas supply. Therefore, under the collocation of multiple inlet pipelines and multiple outlet pipelines, the present disclosure can save the design cost of a considerable gas distribution pipeline and the equipment purchase cost, can reduce the space for a gas distribution box, and can replace multiple separate ordinary mass flow controllers.

Besides the above-described technical problem to be solved by some embodiments of the present disclosure, the technical features of the technical solution and the advantages brought by these technical features of the technical solution, other technical features of some embodiments of the present disclosure and advantages brought by these technical features will be further illustrated with reference to the accompanying drawings.

### BRIEF DESCRIPTION OF THE DRAWINGS

FIG. 1 is a schematic structure diagram of a mass flow controller according to Embodiment 1 of the present disclosure;

FIG. 2 is a schematic structure diagram of a mass flow controller according to Embodiment 2 of the present disclosure; and

FIG. 3 is a schematic structure diagram of a mass flow controller according to Embodiment 3 of the present disclosure.

In the drawings, 1: inlet pipeline; 2: outlet pipeline; 3: control component; 4: potential monitoring element; 5: first control valve; 6: second control valve; 11: main pipeline; 12: auxiliary pipeline; 13: Venturi pipe; 31: calculation control unit; 32: data exchange module; 41: gas flow bypass; 42: thermally sensing potential difference element; 421: potentiometer; 422: heater; 423: thermocouple.

### DETAILED DESCRIPTION OF THE EMBODIMENTS

In order to make the objectives, technical solutions and advantages of the embodiments of the present disclosure clearer, the technical solutions in the embodiments of the present disclosure will be clearly and completely described in an exemplary embodiment below with the drawings in the embodiments of the present disclosure. Obviously, the described embodiments are only part of the embodiments of the present disclosure, not all of the embodiments. On the basis of the embodiments of the present disclosure, all other embodiments obtained on the premise of no creative work of a person of ordinary skill in the art fall within the scope of protection of the present disclosure.

In the descriptions of the present disclosure, unless otherwise specified and limited, it should be noted that terms “mounting”, “mutual connection” and “connection” should be generally understood. For example, the term may be fixed connection, or detachable connection or integrated connection, may be mechanical connection or electrical connection, may be direct connection, may be indirect connection through an intermediate, or may be internal communication between two elements. A person of ordinary skill in the art may understand specific meanings of the above terms in the present disclosure according to specific situations.

In addition, in the descriptions of the present disclosure, unless otherwise specified and limited, “multiple”, “multiple pieces” and “multiple groups” mean two or more, and “several”, “several pieces” and “several groups” mean one or more.

### Embodiment 1

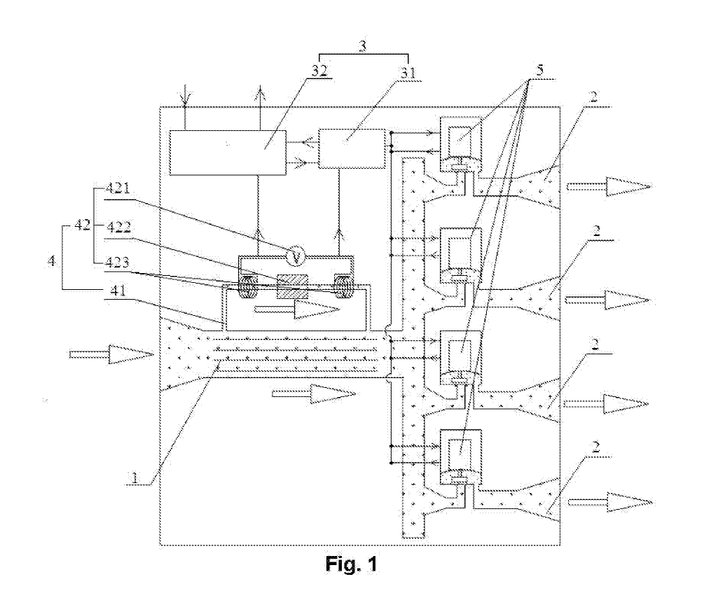

As shown in FIG. 1, the mass flow controller provided according to the embodiment of the present disclosure includes an inlet pipeline 1, an outlet pipeline 2 and a control component 3. There are multiple inlet pipelines 1 and/or multiple outlet pipelines 2. One end of each inlet pipeline 1 is an air inlet, and the other end of each inlet pipeline 1 is communicated with each outlet pipeline 2. Each inlet pipeline 1 is provided with a potential monitoring element 4. The control component 3 is connected to each potential monitoring element 4, and the control component 3 controls gas flow of each inlet pipeline 1 and each outlet pipeline 2.

In the mass flow controller of the present disclosure, gas enters through the air inlet of each inlet pipeline 1, each potential monitoring element 4 transmits a potential difference caused by gas flowing in the corresponding inlet pipeline 1 to the control component 3, and the control component 3 converts gas flow according to the potential difference, and responding controls the gas inflow of each inlet pipeline 1 and the gas outflow of each outlet pipeline 2 according to converted data. In order to achieve the purpose of uniformly supplying gas into a large-volume reaction chamber, in an embodiment of the present disclosure, multiple outlet pipelines 2 may be provided to supply gas into the reaction chamber, and the control component 3 controls the gas flow of each outlet pipeline 2, so as to meet the requirements for uniformly supplying a large amount of gases. In order to achieve the purpose of supplying gas into the reaction chamber after uniform mixing of multiple gases, in an exemplary embodiment of the present disclosure, multiple inlet pipelines 1 may be provided, and the control component 3 controls gas flow of each inlet pipeline 1, mixes gases in the inlet pipeline 1 according to the content requirements of each gas, and then supplies the gas into the reaction chamber, so as to meet the requirements of uniform gas mixing. In order to achieve the purpose of uniform gas supply after uniform mixing of multiple gases, in an exemplary embodiment of the present disclosure, multiple inlet pipelines 1 and multiple outlet pipelines 2 may be provided, and the control component 3 controls gas flow of each inlet pipeline 1 and outlet pipeline 2, so as to meet the requirements of uniform gas mixing and uniform gas supply. Therefore, under the collocation of multiple inlet pipelines 1 and multiple outlet pipelines 2, some embodiments of the present disclosure can save the design cost of a considerable gas distribution pipeline and the equipment purchase cost, can reduce the space for a gas distribution box, and can replace multiple separate ordinary mass flow controllers.

Herein, in the present embodiment, there is one inlet pipeline 1, and there are multiple outlet pipelines 2. Each outlet pipeline 2 is provided with a first control valve 5, and first control valves 5 are connected to the control component 3. Herein, each first control valve 5 is a piezoelectric ceramic valve. The first control valves 5 may be of the same type or may be a valve of any flow type. The piezoelectric ceramic valve is used in the present embodiment. Each piezoelectric ceramic valve and the control component 3 establish a mathematical model separately, and meanwhile, multiple piezoelectric ceramic valves and the control component 3 need to establish an overall mathematical model. Multiple piezoelectric ceramic valves may be integrally controlled while increasing or decreasing the regulating flow to achieve the overall control of the gas flow of the outlet pipelines 2 of the mass flow controller. It is also possible to achieve the single control of each piezoelectric ceramic valve. The flow may be adjusted by adjusting one or more of the piezoelectric ceramic valves. Or, while keeping the overall flow unchanged, the flow of some outlet pipelines 2 may be decreased simultaneously, the flow of some outlet pipelines 2 may be kept unchanged, and the flow of some other outlet pipelines 2 may be increased. It is convenient to adjust the flow of each outlet pipeline 2 according to the mathematical model so as to achieve the purpose of uniformly supplying gas to a large-volume reaction chamber.

Herein, the potential monitoring element 4 includes a gas flow bypass 41 and a thermally sensing potential difference element 42, both ends of the gas flow bypass 41 are communicated with the inlet pipeline 1, the thermally sensing potential difference element 42 is disposed on the gas flow bypass 41, and the thermally sensing potential difference element 42 is connected to the control component 3. The gas flow bypass 41 is disposed on the inlet pipeline 1. When gas enters the inlet pipeline 1, a small portion passes through the gas flow bypass 41 and then merges into the inlet pipeline 1, and the thermally sensing potential difference element 42 is disposed on the gas flow bypass 41. When the gas in the gas flow bypass 41 does not flow, the thermally sensing potential difference element 42 does not generate a potential difference signal. When the gas in the gas flow bypass 41 flows, the thermally sensing potential difference element 42 generates a potential difference signal, and inputs the potential difference into the control component 3, so that the control component 3 controls the flow of multiple outlet pipelines 2 accordingly.

Herein, the thermally sensing potential difference element 42 includes a potentiometer 421, a heater 422 and two thermocouples 423. The heater 422 and the thermocouples 423 are disposed on the gas flow bypass 41, and the heater 422 is located between the two thermocouples 423. The potentiometer 421 is respectively connected to the two thermocouples 423 to measure a potential difference between the two thermocouples 423, and the potentiometer 421 is connected to the control component 3 to output the potential difference to the control component 3. A front thermocouple, the heater 422 and A rear thermocouple are sequentially disposed on the gas flow bypass 41. When the gas in the gas flow bypass 41 does not flow, heat generated by the heater 422 will not be brought to the rear thermocouple by the gas. The front thermocouple and the rear thermocouple have the same temperature. When the gas in the gas flow bypass 41 flows, the heat of the heater 422 will be continuously brought to the rear thermocouple. The temperature of the rear thermocouple and the temperature of the front thermocouple are different, and a potential difference is generated. After the potentiometer 421 detects the potential difference, the potential difference is input to the control component 3.

Herein, the control component 3 includes a calculation control unit 31 and a data exchange module 32, the calculation control unit 31 is connected to the data exchange module 32, and the potential monitoring element 4 and the first control valve 5 are both connected to the calculation control unit 31. The potentiometer 421 inputs the potential difference to the calculation control unit 31. According to the corresponding mathematical model, the total gas flow in the entire mass flow controller can be calculated, and then a calculation result is output to the outside through the data exchange module 32. If the calculation result is different from flow data preset by the data exchange module 32, the, calculation control unit 31 starts the first control valves 5, adjusts the opening degree of the valve, and maintains the sum of the flow of the outlets of all outlet pipelines 2 of the mass flow controller to be the same as the flow set by the data exchange module 32.

### Embodiment 2

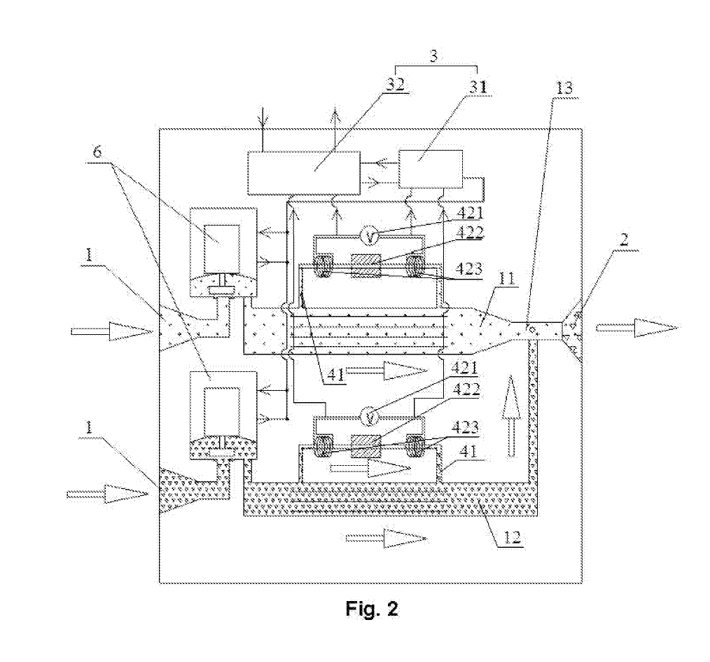

As shown in FIG. 2, the mass flow controller provided according to Embodiment 2 of the present disclosure is basically the same as that in Embodiment 1, except that there are multiple inlet pipelines 1 in the present embodiment and there is one outlet pipeline 2. Each inlet pipeline 1 is provided with a second control valve 6, and second control valves 6 are connected to the control component 3. Herein, each second control valve 6 is a piezoelectric ceramic valve, and the second control valves 6 are connected to the calculation control unit 31. The second control valves 6 may be of the same type or may be a valve of any flow type, The piezoelectric ceramic valve is used in the present embodiment. Each piezoelectric ceramic valve and the control component 3 establish a mathematical model separately, and meanwhile, multiple piezoelectric ceramic valves and the control component 3 need to establish an overall mathematical model. Multiple piezoelectric ceramic valves may be integrally controlled while increasing or decreasing the regulating flow to achieve the overall control of the gas flow of the inlet pipelines 1 of the mass flow controller. After each gas needing to be mixed enters the inlet pipeline 1, a separate second control valve 6 is needed to control the flow. A proper proportion of uniformly mixed process gas may be obtained at the outlet pipeline 2 to achieve the purpose of uniformly mixing multiple gases through a mass flow controller, without an additional standby state beyond the process requirements, such as multiple gas premixing.

Herein, the multiple inlet pipelines 1 include a main pipeline 11 and auxiliary pipeline 12, and the main pipeline 11 and the auxiliary pipeline 12 are gathered at the tail end and are connected to each outlet pipeline 2. The second control valves 6 on the main pipeline 11 and the auxiliary pipeline 12 may be integrally controlled to mix gases proportionately. It is also possible to fix the flow of a gas to adjust the flow of another gas, or to mix gases in any proportion or randomly close a certain gas to achieve single gas supply.

Herein, a pipeline structure gathered at the tail end of the multiple inlet pipelines 1 is a Venturi pipe 13. In the present embodiment, the second control valve 6 is disposed at the front end of the potential monitoring element 4, and multiple gases are mixed at the tail end of the multiple inlet pipelines 1. The Venturi pipe 13 structure can ensure uniform gas mixing. It is especially suitable to a situation where the flow difference of two gases is relatively large or the inlet pressure is similar.

### Embodiment 3

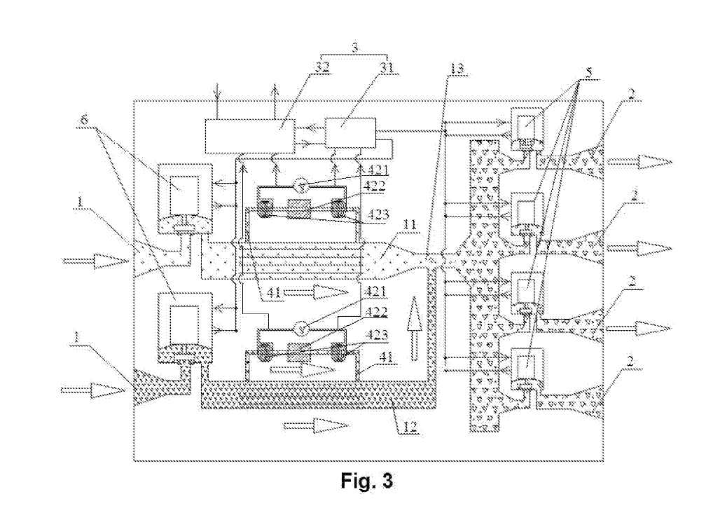

As shown in FIG. 3, the mass flow controller provided according to Embodiment 3 of the present disclosure is basically the same as that in Embodiment 1, except that there are multiple inlet pipelines 1 in the present embodiment, each inlet pipeline 1 is provided with a second control valve 6, and second control valves 6 are connected to the control component 3. Herein, each second control valve 6 is a piezoelectric ceramic valve, and the second control valves 6 are connected to the calculation control unit 31. The second control valves 6 may be of the same type or may be a valve of any flow type. The piezoelectric ceramic valve is used in the present embodiment. Each piezoelectric ceramic valve and the control component 3 establish a mathematical model separately, and meanwhile, multiple piezoelectric ceramic valves and the control component 3 need to establish an overall mathematical model. Multiple piezoelectric ceramic valves may be integrally controlled while increasing or decreasing the regulating flow to achieve the overall control of the gas flow of the inlet pipelines 1 of the mass flow controller. Under the overall control of the control component 3, the first control valves 5 and the second control valves 6 adjust the gas flow of the inlet pipelines 1 and the outlet pipelines 2, thereby not only achieving the purpose of uniformly mixing multiple gases, but also achieving the purpose of uniformly supplying a large amount of gases.

Herein, a pipeline structure gathered at the tail end of the multiple inlet pipelines 1 is a Venturi pipe 13. In the present embodiment, each second control valve 6 is disposed at the front end of the corresponding potential monitoring element 4, and multiple gases are mixed at the tail end of the multiple inlet pipelines 1. The Venturi pipe 13 structure can ensure uniform gas mixing. It is especially suitable to a situation where the flow difference of two gases is relatively large or the inlet pressure is similar.

Optionally, the multiple inlet pipelines 1 include a main pipeline 11 and auxiliary pipeline 12, and the main pipeline 11 and the auxiliary pipeline 12 are gathered at the tail end and are connected to the outlet pipeline 2. The second control valves 6 on the main pipeline 11 and the auxiliary pipeline 12 may be integrally controlled to mix gases proportionately. It is also possible to fix the flow of a gas to adjust the flow of another gas, or to mix gases in any proportion or randomly close a certain gas to achieve single gas supply.

The above content is the embodiment of the present disclosure where multiple outlet pipelines are provided when one inlet pipeline is provided and one or more outlet pipelines may be provided when multiple inlet pipelines are provided, which is intended to protect the mass flow controller structure within the range of the three conditions.

To sum up, in the mass flow controller of the present disclosure, gas enters through the air inlet of each inlet pipeline, each potential monitoring element transmits a potential difference caused by gas flowing in the corresponding inlet pipeline to the control component, and the control component converts gas flow according to the potential difference, and responding controls the gas inflow of each inlet pipeline and the gas outflow of each outlet pipeline according to converted data. In order to achieve the purpose of uniformly supplying gas into a large-volume reaction chamber, in an embodiment of the present disclosure, multiple outlet pipelines may be provided to supply gas into the reaction chamber, and the control component controls the gas flow of each outlet pipeline, so as to meet the requirements for uniformly supplying a large amount of gases. In order to achieve the purpose of supplying gas into the reaction chamber after uniform mixing of multiple gases, in an exemplary embodiment of the present disclosure, multiple inlet pipelines may be provided, and the control component controls gas flow of each inlet pipeline, mixes gases in the inlet pipeline according to the content requirements of each gas, and then supplies the gas into the reaction chamber, so as to meet the requirements of uniform gas mixing. In order to achieve the purpose of uniform gas supply after uniform mixing of multiple gases, in the an exemplary embodiment of the present disclosure, multiple inlet pipelines and multiple outlet pipelines may be provided, and the control component controls gas flow of each inlet pipeline and outlet pipeline, so as to meet the requirements of uniform gas mixing and uniform gas supply. Therefore, under the collocation of multiple inlet pipelines and multiple outlet pipelines, some embodiments of the present disclosure can save the design cost of a considerable gas distribution pipeline and the equipment purchase cost, can reduce the space for a gas distribution box, and can replace multiple separate ordinary mass flow controllers.

It shall be, finally, noted that: the above embodiments are merely intended to illustrate the technical solutions of the present disclosure and do not limit the technical solutions; although the present disclosure is illustrated in detail with reference to the above embodiments, a person of ordinary skill in the art shall understand that they can still modify the technical solutions recorded by the above embodiments or can equivalently replace some of the technical features; and these modifications or replacements do not make the essences of corresponding technical solutions depart from the spirit and scope of the technical solutions in each embodiment of the present disclosure.

What is claimed is:

1. A mass flow controller, wherein the mass flow controller comprises an inlet pipeline, an outlet pipeline and a control component, there are multiple inlet pipelines and/or multiple outlet pipelines; one end of each inlet pipeline is an air inlet, and the other end of each inlet pipeline is communicated with each outlet pipeline; each inlet pipeline is provided with a potential monitoring element; and the control component is connected to each potential monitoring element, and the control component controls gas flow of each inlet pipeline and each outlet pipeline.

2. The mass flow controller as claimed in claim 1, wherein when there are multiple outlet pipelines, each outlet pipeline is provided with a first control valve, and the first control valve is connected to the control component.

3. The mass flow controller as claimed in claim 2, wherein when there are multiple inlet pipelines, each inlet pipeline is provided with a second control valve, and the second control valve is connected to the control component.

4. The mass flow controller as claimed in claim 1, wherein each potential monitoring element comprises a gas flow bypass and a thermal potential sensor, both ends of the gas flow bypass are communicated with the corresponding inlet pipeline, and the thermal potential sensor is disposed on the gas flow bypass, and the thermal potential sensor is connected to the control component.

5. The mass flow controller as claimed in claim 4, wherein each thermal potential sensor comprises a potentiometer, a heater and two thermocouples; the heater and the thermocouples are disposed on the corresponding gas flow bypass, and the heater is located between the two thermocouples; and the potentiometer is respectively connected to the two thermocouples to measure a potential difference between the two thermocouples, and the potentiometer is connected to the control component to output the potential difference to the control component.

6. The mass flow controller as claimed in claim 1, wherein the multiple inlet pipelines comprise a main pipeline and an auxiliary pipeline, and the main pipeline and the auxiliary pipeline are gathered at the tail end and are connected to each outlet pipeline.

7. The mass flow controller as claimed in claim 6, wherein a pipeline structure gathered at the tail end of the multiple inlet pipelines is a Venturi pipe.

8. The mass flow controller as claimed in claim 3, wherein the control component comprises a calculation control unit and a data exchange module, wherein the calculation control unit is connected to the data exchange module; and the potential monitoring elements, the first control valves and the second control valves are connected to the calculation control unit.

9. The mass flow controller as claimed in claim 2, wherein each first control valve is a piezoelectric ceramic valve.

10. The mass flow controller as claimed in claim 3, wherein each second control valve is a piezoelectric ceramic valve.
